(19) United States
(12) Patent Application Publication
(10) Pub. No.: US 2007/0089350 A1
(43) Pub. Date: Apr. 26, 2007

(54) Outrigger with automatic hooksetter

(76) Inventor: John Peter Elliott, Marston Mills, MA (US)

Correspondence Address: William D. Breneman, Esq.;BRENEMAN & GEORGES, 3150 Commonwealth Avenue, Alexandria, VA, 22305, US

(21) Appl. No.: 11/253,598

(22) Filed: Oct. 20, 2005

(51) Int. Cl. A01K 97/11

(52) U.S. Cl. 43/15; 43/21.2

(57) ABSTRACT

A fishing outrigger with automatic hooksetting is provided by employing a mounting arm having at one end a device for setting the angular position of the mounting arm to a boat and having at the other end a taper and pivot for pivotally mounting and setting the angular position of the mounting arm to a fishing rod support arm which fishing rod support arm includes a device for setting the position of a fishing rod and reel with respect to the fishing rod support arm. The novel fishing outrigger set the pivot or hinge at an angle to the horizon and provides an armed position and a hook setting position triggered by a fish taking the lure or bait.

### CROSS REFERENCE TO RELATED APPLICATIONS

Not applicable.

### Statement Regarding Federally Sponsored Research or Development

Not applicable.

### Incorporation-by-Reference of Material Submitted on Compact Disc

Not applicable.

### Reference to a “Microfiche Appendix”

Not applicable.

### BACKGROUND OF THE INVENTION

1. Field Of The Invention

The invention pertains a fishing outrigger with an automatic hooksetter. More particularly the novel fishing outrigger with automatic hooksetter includes mechanical structure and a combination of critical angles for angularly fixing the outrigger support to a rod holder in the gunwale of the boat and providing a hinged connection between the outrigger support and the rod holder support arm while rotationally fixing the position of the rod and the reel in the novel fishing outrigger. The hinge and tapered connection between the outrigger support and the rod holder support arm sets the angular position between the rod holder support arm sets the angular position between the rod holder and the support arm to provide an armed position for the novel fishing outrigger. The combination of angular rotational and positioning features of the novel fishing outrigger allows the novel fishing outrigger to not only fix the position and support the fishing rod and reel in a precise position but also allows the novel fishing outrigger to automatically set the hook when the fishing bait is taken without the use of springs or additional levers.

2. Description of the Related Art Including in the U.S. Information Disclosed Under 37 CFR 1.97 and 1.98

The best known prior art in use includes outriggers having a support arm welded to a rod holder which in some cases have a rod supporting pin. Examples of such outriggers currently in use include Windline's stainless steel rod rigger and Reliable's rod rigger. These and other such outriggers all have a support arm which are designed to fit into gunwale rod holders which are mounted to the gunwale of the boat. The gunwale rod holders are typically installed in the gunwale of a boat and have an angular flange that sets the rod holder at 0 degrees, 15 degrees or 30 degrees with the 30 degree angle being the most commonly used. These prior art gunwale rod holders may be used with or without an outrigger. The gunwale rod holders, for example those made by Lee's of Florida and other manufacturers, typically accept rods and hold the rods at an angle of 0 degrees, 15 and 30 degrees to the gunwale of the boat. The disadvantage however of using a rod with a rod holder is that only one or two rods can be placed along the back of the boat. As a result outriggers such as the Windline's rod rigger and others allow the disposition of rod holders along the sides of the boat so that lines can be also set along the sides of the boat without entanglement.

The disadvantage of such rod riggers is that they are fixed and a fisherman placing the rod into the open end of the rod rigger must lean over the side of the boat. This disadvantage is compounded when a fish strikes the bait since a fisherman must then remove the rod from the rod rigger. In heavy seas an inexperienced fisherman can lose balance, can lose the rod or fall over while attempting to secure the rod and reel or remove the rod and reel from the outrigger.

The prior art outriggers also do not automatically set the hook but are merely for the purpose of allowing additional lines to be disposed along the gunwale on each side of the boat.

The best known prior art after conducting a patented prior art search was Maher U.S. Pat. No. 4,468,878. Maher U.S. Pat. No. 4,468,878 discloses an outrigger fishing rod holder having a cylindrical rod holder pivotally mounted to an elongated U-shaped bracket. The elongated U-shaped mounting bracket terminates in notched plate which together with rivet head pins and a spring provides for mounting to a mounting plate which includes holes for screwing the mounting plate into the side of the boat.

The Maher U.S. Pat. No. 4,468,878 outrigger does not have an automatic hooksetting feature and does not discuss any particular rotational angular fixing the fishing rod and reel with respect to the outrigger by utilizing a rod mounting pin. While Maher U.S. Pat. No. 4,468,878 indicates the fishing rod can coact with a pin 11 no such pin is shown in the drawings of Maher, nor is the positioning of that pin with respect to the rod holder disclosed in a manner sufficient to describe the exact positioning of the rod and reel necessary to provide an automatic hook setting feature by having a combination of critical angles. Moreover Maher U.S. Pat. No. 4,468,878 mounts the mounting bracket perpendicular to the gunwale of the boat which would not provide the automatic hook setting feature which requires not only the angular positioning of the rod holder support arm with respect to the rod holder but also a rotational angular fixing of the rod and reel in the rod holder support arm in order to provide an automatic hook setting function. Maher U.S. Pat. No. 4,468,878 also unlike the invention appears to pertain to a jigging device as nothing is said about the motion of the boat to make the device work. The invention in contrast relies upon the forward motion or trolling of the boat to work in combination with a combination of angles and the action of a fish taking the lure or bait as the boat is in motion.

Other prior art which provides for automatic hook setting for rod holders involves a complex arrangement of levers and springs as well as rod and reel positioning in order to provide for an automatic hook setting function. Examples of prior art having rod holders with automatic hook setting functions include Updike U.S. Pat. No. 5,542,205 and Flisak U.S. Pat. No. 5,524,376. This representative prior art of automatic hook setting devices utilizes a complicated combination of springs and levers for automatically setting the hook once the bait is taken.

Unlike the prior art the novel outrigger with automatic hooksetter automatically sets hooks once the bait is taken by providing a combination pivoting action-reaction mechanism utilizing the unique angled positioning of the rod and reel that dynamically hold the rod and reel in an armed position by a combination of unique angles which concentrate the center of gravity around the pivot point. Once the dynamic equilibrium in which the rod holder is held is compromised by the action of a fish taking the bait the reaction results in the pivot point swinging the rod holder, rod and reel from an armed position substantially perpendicular to the gunwale of the boat to an upright position by utilizing the resiliency in the rod to pull the line in an opposite direction to set the hook automatically and place the rod and reel in a convenient position to be removed from the novel outrigger with automatic hooksetter.

Other prior art for pivotally mounting a rod includes Stockton et al. U.S. Pat. No. 5,546,693 which pertains to a rod holder having a pivot point intermediate the ends. The Stockton et al. U.S. Pat. No. 5,546,693 does not provide an automatic hook setting function nor does it teach or suggest the combination of angles necessary to provide for an automatic hook setting function for a rod and reel.

Other prior art such as Hansen et al. U.S. Pat. 5,245,780 provides a combination of levers and motorized mechanical or electromechanical actuators to move the struts to automatically position the outrigger in various positions. Like the other outrigger prior art Hansen et al. U.S. Pat. 4,245,780 does not provide an automatic hook setting outrigger which automatically sets the hook and positions the rod and reel in a position for the fisherman to remove the rod from the outrigger without exposing the fisherman to losing his balance, losing the rod or reel overboard or losing the hooked fish.

The prior art has not provided for a simple outrigger device that includes an automatic hook setting function while having a reliable mechanism which allows the rod to be replaced in the novel outrigger without reaching over the gunwale, allows the rod to be set in an armed position without the use of springs, levers or other devices and provides a reliable automatic hook setting feature. The prior art also fails to provide a simple device that relies upon the action-reaction principle of physics to allow a tug on the line to result in the pivoting of the novel outrigger rod holder and utilize the resiliency of the rod to automatically set the fish hook.

The prior art also does not provide for an outrigger having not only an automatic hook setting action but provide for the positioning of the rod once the hook is set in a position substantially perpendicular to the gunwale of the boat to allow the rod to be lifted out of the outrigger without endangering the safety of the fisherman or other passengers fishing on the fishing boat by positioning the rod and reel in a position so it can be easily lifted out of outrigger while a hooked fish is on the line.

The prior art also does not provide a simple inexpensive and reliable outrigger for use in saltwater environments for reliably hooking a fish by relatively inexperienced fishermen. The novel outrigger with automatic hooksetter was created to accommodate the foregoing limitations as well as others that will become apparent from the drawing and disclosure of the invention.

### SUMMARY OF THE INVENTION

The invention provides a simple outrigger device for rotatably fixing the position of a rod and reel with respect to a gunwale of a boat so that when a fish strikes the bait the novel outrigger automatically pivots to set the hook and at the same time place the reel in a substantially upright position with respect to the gunwale of the boat. The novel outrigger achieves its advantages without the use of springs and complicated levering mechanisms and triggers and provides a reliable simple construction for use in a saltwater environment.

The novel outrigger with automatic hooksetter includes a mounting arm designed to fit into a standard gunwale mounted rod holder which are set in the gunwale at an angle of 30 degrees or includes a bend for setting the attachment of the mounting arm at an angle of greater than 15 degrees or about 20 degrees to 45 degrees and preferably 30 degrees. The outrigger mounting arm includes a slot at one end for rotatably fixing the position of the mounting arm with respect to the gunwale of the boat and at the other end includes a hinge for pivotally mounting a rod holder support arm with respect to the mounting arm. The rod holder support arm also preferably includes a tapered end for fixing the angular position between the rod holder support arm and the mounting arm and for pivotally mounting the rod support arm at an angle of about 100 to 120 degrees and preferably 105 degrees to the mounting arm.

Disposed opposite to the taper on the end of the mounting arm is a second taper which is tapered at an angle sufficient to allow the rod holder support arm to be pivoted to a position substantially parallel to the support arm. A pin is disposed approximately at the end of the rod holder support arm to rotationally engage and fix the angular position of a rod and reel within the rod holder support arm.

The combination of angles provide for the engagement of the rod and reel in a rotational position such that the rod and reel are locked in a position where the reel is rotated and locked at an angle above the horizon so that the center of gravity of the reel is above the pivot point of the hinge between the mounting arm and the rod holder support arm. A pin is disposed substantially at the end of the rod holder support arm to maintain the rod holder in this position so that the line extends from the reel through the rod to the tip of the rod which trails behind the boat and maintains the novel outrigger with in an armed position. The armed position of the novel outrigger with automatic hooksetter is further assisted by the 30 degree angle provided by the rod holder disposed in the gunwale of the boat. In addition the rotational positioning of the novel outrigger with automatic hooksetter is maintained by a slot at the other end of the support arm which engages a pin at the end of the rod holder which pin would normally engage the end of the rod in the prior art.

The position of the rod and reel in the novel outrigger with automatic hooksetter is maintained in the armed position until the line trailing behind the boat during trolling is pulled or yanked by a fish taking the bait. Once the line is pulled or yanked by a fish taking bait the novel outrigger with automatic hooksetter swings from its armed position to its hooked position with a pivoting of the rod a response to the strike the fish at the bait in an action-reaction pivoting of the hinge from its armed position to its hooked position utilizing the length of the arm provided by the rod together with the resiliency of the rod to yank back the line and automatically hook the fish when the rod holder support arm and rod reaches the hooked position.

In an alternative embodiment of the invention the mounting arm for the novel outrigger with hook setter is bent at an angle of greater than 5 degrees and about 10 to 40 degrees and preferably 30 degrees to allow a portion of the mounting arm to be mounted perpendicular to the gunwale of a boat as where either a perpendicular hole exists in the gunwale of the boat or where a prior art rod holder with a 0 or a 15 degree angle is utilized in the gunwale of a boat. The bend in the support allows the novel outrigger to maintain an angle of about 20 to 40 degrees with respect to the gunwale of the boat. In this manner the rod and reel are then engaged in the same angular offset as previously described so that the reel provides the same armed position and hooked position as the preferred embodiment of the invention even though an angled gunwale mounted rod holder is not utilized.

The novel outrigger with automatic hooksetter includes a pair of flanges welded to the rod support arm which flanges include in the preferred embodiment a number of holes and a pin for adjusting the sensitivity of the hook setting function of the novel outrigger. The adjustment of the sensitivity of the hooksetter is advantageous in varying wave conditions where the fishing boat is operating in running seas. In such conditions the pivot point between the mounting arm and rod holder support arm can be adjusted to accommodate the size of the waves to prevent the accidental arming of the novel outrigger with automatic fish setting by wave action in combination with the trolling speed of the fishing boat.

The novel outrigger with automatic hooksetter in addition to providing advantages in allowing more lines to be disbursed along the sides of the boat also allows quick and easy placement of rods and removal of rods from the novel outrigger without the necessity of novice fishermen having to lean over the side of the boat in an effort to attach or remove their rods from the novel outrigger. The pivoting of the rod holder support arm from its armed position to its hooked position can be utilized to pivot the rod holder into its hooked position and allow the rod to be placed into the rod holder while the rod holder is disposed substantially parallel to the mounting arm and thereafter pivoted from its upright hooked position down to its armed position.

The novel outrigger is simple in construction and design and is durable in saltwater environments and can be manufactured at low cost and is of easy maintenance and is well suited to fishing operations utilizing fishing parties. The novel outrigger with automatic hooksetter further allows fishermen the opportunity to not have to monitor their line 100% of the time while fishing and allows novice fishermen the ability to catch fish without a constant monitoring of the fishing line during fishing. The novel outrigger is particularly useful since it does not utilize springs, complicated levers or large numbers of moving parts that are complicated to maintain, difficult to use and require a great expense or maintenance in the operation of the outrigger.

The features of the novel outrigger with hook setter include (1) automatic visual alert of a hook up or strike while trolling, (2) the fishing rod and outrigger automatically return to a position inside the boat upon hooking the fish thereby eliminating the task of reaching overboard to take the rod out of the holder, (3) the outrigger accommodates side mounting to double the area fished whiled trolling and provides an option to add a third line down the middle of the boat, and (4) is compatible with existing standard 30 degree mounted rod holders.

### BRIEF DESCRIPTION OF THE SEVERAL VIEWS OF THE DRAWINGS

In a further explanation of the invention exemplary embodiment of the invention including the best mode of the invention will be described with reference to the accompanying drawings in which:

FIG. 1 is a side elevational view of the novel fishing outrigger with an automatic hooksetter in accordance with the invention;

FIG. 2 is a perspective view of the mounting arm of the novel fishing outrigger with automatic hooksetter;

FIG. 3 is a perspective view of the rod holder support arm of the novel outrigger with hooksetter;

FIG. 4 is a perspective view of the novel outrigger with hooksetter illustrating one of the pivotal attachment between the mounting arm and the rod holder support arm;

FIG. 5 is a side elevational view of the mounting arm and rod holder support arm illustrating the angular relationship between the mounting arm and the rod holder support arm;

FIG. 6 is a side elevational view similar to FIG. 5 illustrating the positional relationship between the mounting arm and the rod holder support arm and the interconnecting hinge;

FIG. 7 is a perspective view of the mounting of the novel outrigger with automatic hooksetter with respect to the gunwale of a boat;

FIG. 8 is a further view of the relationship between the rod holder support arm and the mounting arm of the novel outrigger with automatic hooksetter;

FIG. 9 is a side elevational view partly in section illustrating the mounting of the novel automatic hooksetter in the rod holder in a gunwale of a boat;

FIG. 10 is a side elevational view of the angular positioning of the rod and reel in the novel outrigger with automatic hooksetter;

FIG. 11 is a side elevational view illustrating the novel outrigger with automatic hooksetter in its armed position;

FIG. 12 is a side elevational view illustrating the pivoting of the novel outrigger with automatic hook setting from its armed position to its hook setting position;

FIG. 13 is a side elevational view of the novel outrigger with hook setting illustrating its motion to the hooksetting position;

FIG. 14 is a side elevational view of the novel outrigger with hooksetter in its hooked position;

FIG. 15 is a side elevational view of an alternative embodiment of the novel outrigger with automatic hooksetter having an angled mounting arm for supporting the novel outrigger with hooksetter in a 0 degree tapered rod holder or gunwale hole;

FIG. 16 is a front side elevational view illustrating the angular relationship between the mounting arm and the rod holder support arm in relation to the gunwale of a boat; and

FIG. 17 is a side elevational view of FIG. 17 illustrating the angular relationships between the angle in maintaining the rod and reel in its armed position and angular position with respect to the gunwale of a boat.

### DETAILED DESCRIPTION OF THE INVENTION INCLUDING BEST MODE

The invention achieves its advantages by utilizing an interrelationship between at least two angles that allows the invention to provide for an automatic hook setting feature without the use of springs and/or a complicated interrelationship of levers. The relationship between the two angles believed responsible for the novel outrigger with automatic hooksetter is the mounting arm or mounting means which allows the hinge to be disposed partially on its side and at angle of about 20 to 45 degrees and preferably 30 degrees and the angle between the mounting arm and the fishing rod holder support arm which angle is about 5 to 20 degrees and preferably about 10 to 15 degrees. The relationship between these angles at the pivot pin sets the rod and reel in a precise rotational position with respect to the novel outrigger with automatic hooksetter and allows the novel outrigger with automatic hooksetter to automatically pivot from its armed position to its hook setting position when an action or force pulls on the line extending from the tip of the rod. The pivot pin allows the energy from the tug on the line to pivot the novel outrigger with hooksetter from its armed position to its hook setting position by utilizing the reaction to the action and the resilient whip lash of the flexible Rod to pivot the rod and reel from its armed position to the hook setting position and allows the end of the Rod to whip lash in the opposite direction to automatically set the hook.

Due to the critical relationship between the angles a precise setting of the position of the rod and reel in the rod holder support arm is required to provide the action-reaction feature of the novel outrigger with hooksetter. The relationship between the angles is in the preferred embodiment related to the configuration of the mounting arm which is adapted for mounting to standard rod holder mounted 30 degrees to the gunwale of the boat as well as the positioning of the rod and reel as will be described herein after in greater detail.

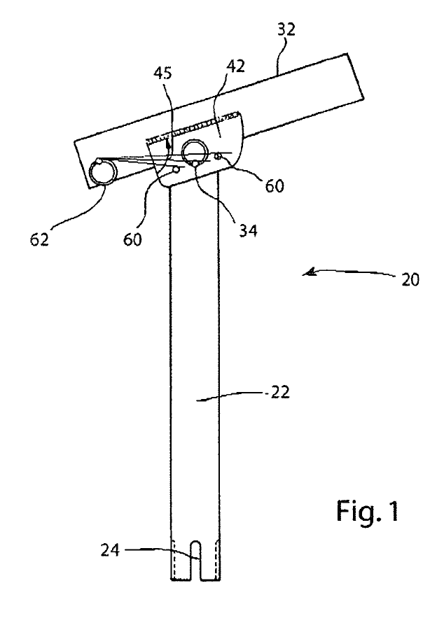

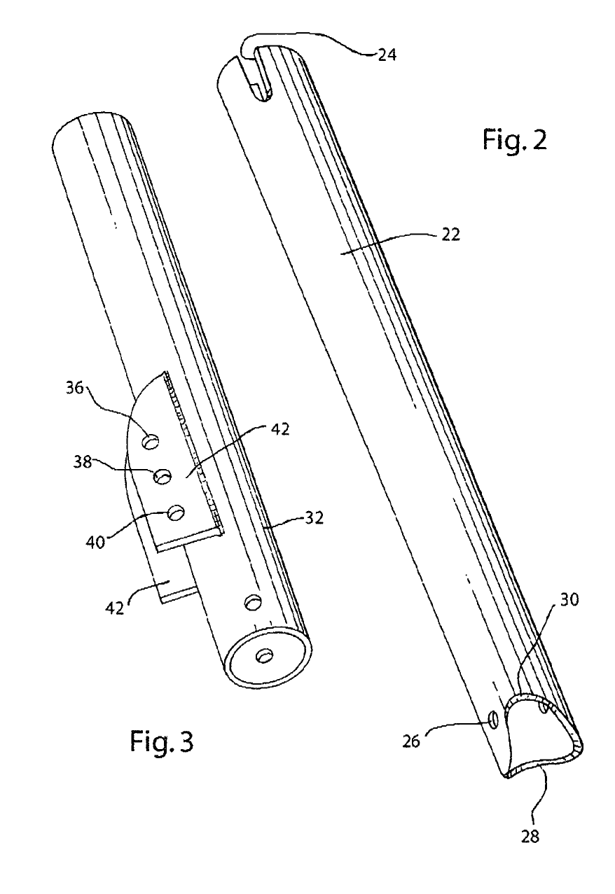

Referring now to FIG. 1 the novel outrigger with automatic hooksetter 20 is illustrated having an elongated mounting arm 22 preferably hollow and cylindrical having notches 24 for rotatably setting and locking the position of mounting arm 22. Mounting arm 22 includes near the other end a throughbore 26 (FIG. 2) and a tapered end having a first taper 28 and a second taper 30. Throughbore 26 and first taper 28 set the position of a rod holder or a rod holder support arm which will be referred to as a rod holder support arm 32 by interconnecting mounting arm 22 with rod holder support arm 32 by a pin 34 which interconnects one of the holes 36, 38 and 40 to flanges 42. The position of pin 34 in holes 36, 38 or 40 forms a hinge having a different center of gravity between mounting arm 22 and rod holder support arm 32.

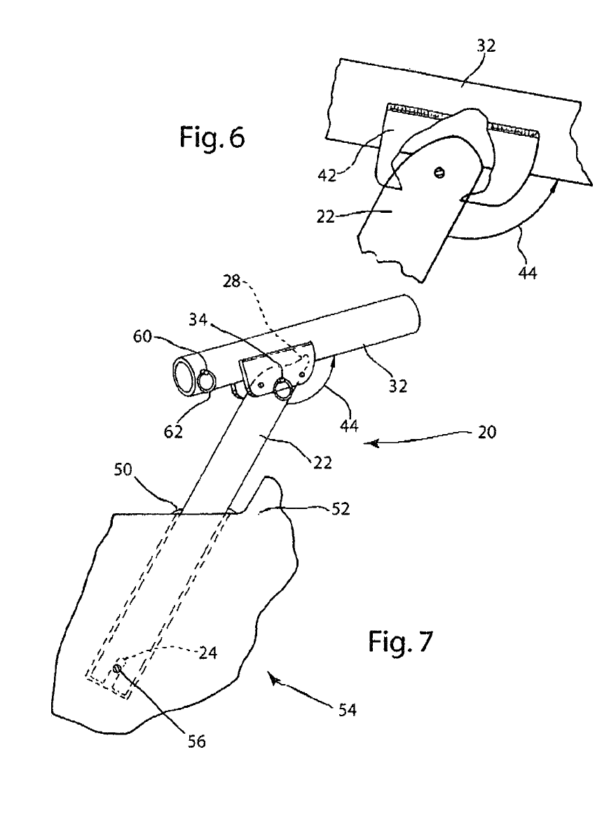

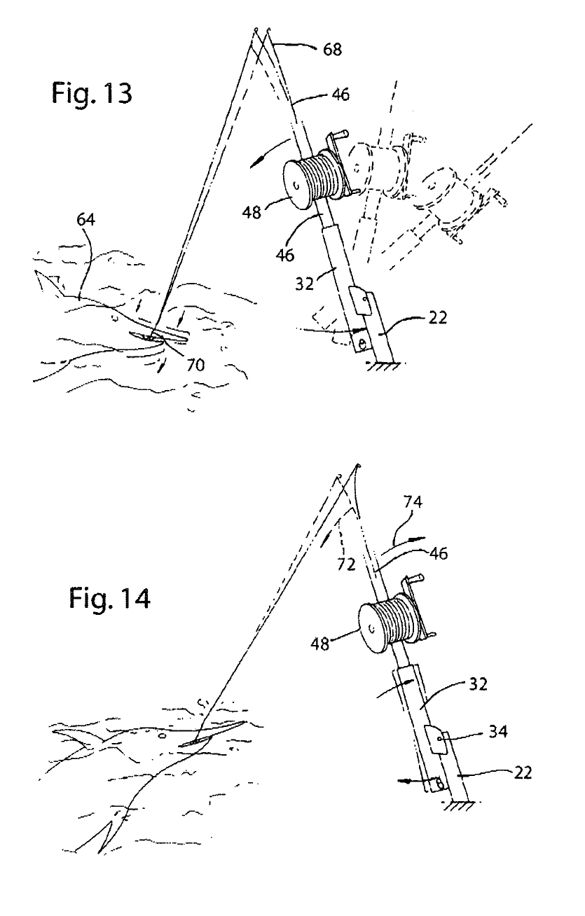

The first taper 28 (FIG. 2) together with pin 34 in one of the holes 36, 38 and 40 sets the armed position of the novel outrigger with hooksetter as is illustrated in FIG. 1 by moving the center of gravity. The angle 44 as illustrated in the cutaway view illustrated in FIG. 5 and 6 stays the same but the angle 45 between pivot pin 34 and rod setting pin 60 is changed. The second taper 30 sets the second position which is the hooked or hook setting position which allows rod support arm 32 to be pivoted to be in substantial parallel alignment with mounting support arm 22 as illustrated in FIG. 13. In addition rod support arm 32 may be placed in parallel alignment with mounting arm 22 to support the rod and reel during the changing of the lure process or after casting the line which allows the fisherman to place the rod 46 and reel 48 in the rod support arm 32 without having to lean over the boat to place the rod in the novel outrigger thus avoiding the possibility of a novice fisherman losing his balance in a rolling sea.

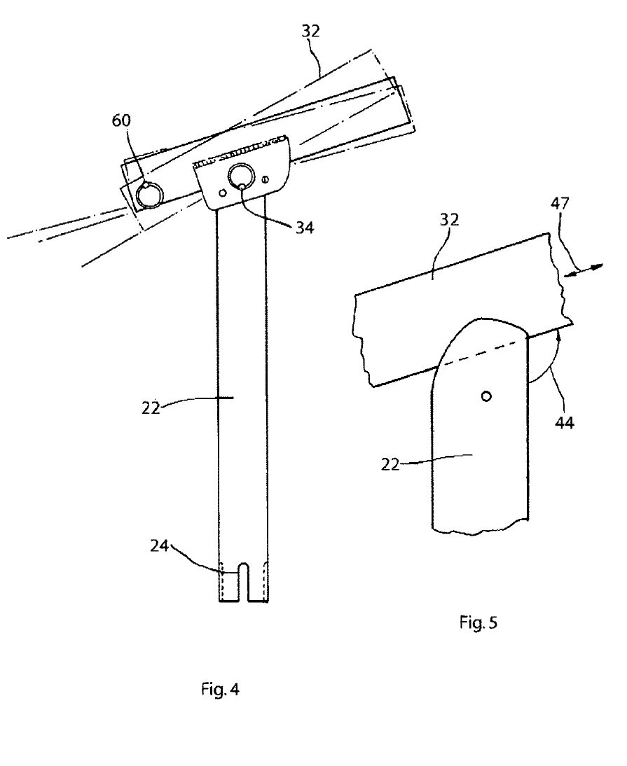

The novel outrigger with hooksetter 20 is fully pivotable between the armed position and hook setting position once pin 34 is inserted into one of the holes 36, 38 and 40 as illustrated in FIG. 4.

The utilization of holes 36, 38 and 40 serves to slightly vary the center of gravity without changing the angle 44 as rod holder support arm 32 is moved forward or backward with respect to mounting arm 22 as shown by arrow 47 as illustrated in FIG. 5 to accommodate varying degrees of sensitivity in the activation of the hinge and the pivoting of rod holder support arm 32 with respect to mounting arm 22 as may be necessary to accommodate the size of waves in a running sea or the force which various types of fish strike the bait.

For example, hole 36 is used to connect mounting arm 22 with rod holder support arm 32 with pin 34 when trolling with a light or small rod, reel and line or in extremely calm seas. Hole 38 is utilized with pin 34 to connect mounting support arm 22 with rod holder support arm 32 for general trolling and with most rods and reels except for especially heavy rods and reels or for light or small rod, reel and line in seas with moderate waves. Hole 40 is used with pin 34 to connect mounting arm 22 to rod holder support arm 32 with pin 34 when trolling with heavy lines for example 100 or more yards with wire plus the use of heavy lures such as bunker, spoons or during rough seas.

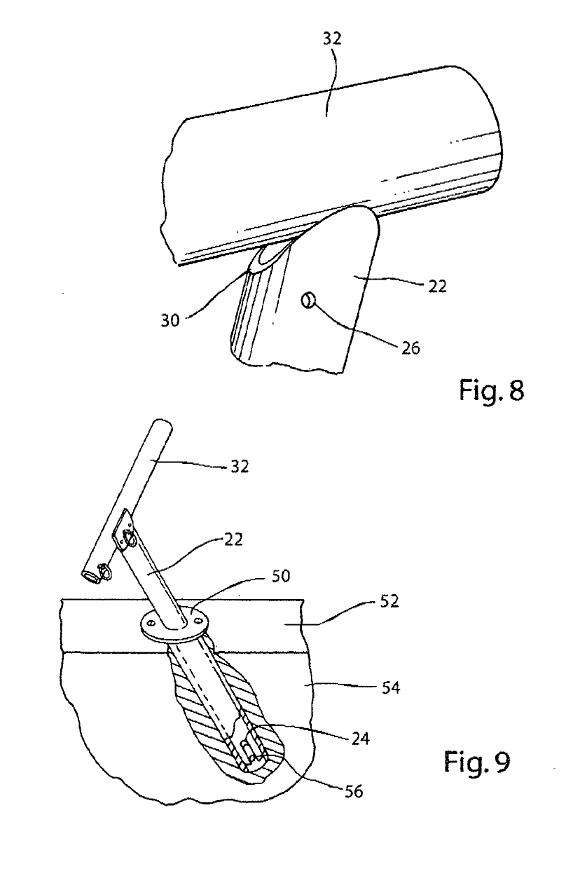

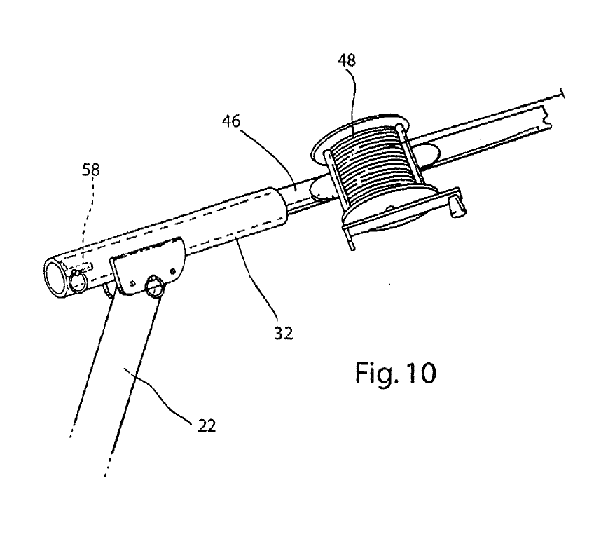

Referring now to FIGS. 7, 8, 9 and 10 the relationship between the novel outrigger with hooksetter and the gunwale of a boat and its relationship to the positioning of a rod and reel in the novel outrigger is illustrated. The novel outrigger with hooksetter 20 is designed to slide into the standard rod holder 50 as is used currently in most fishing boats. The standard rod holder 50 is mounted in the gunwale 52 of the fishing boat 54. The rod holder 50 is available from a number of suppliers such as Lee's of Miami, Fla. and is available in rod holders having a 0 degree, 15 degree mount and 30 degree mount. Most rod holders on most fishing boats are 30 degrees except as is used in tuna fishing. The rod holders 50 include a pin 56 for receiving a standard slot 58 on the end of rod 46 to hold the rod and reel at a 0, 15 or 30 degree angle to the gunwale of the boat (see FIG. 10 for the slot 58).

The mounting elongated support arm 22 includes notches 24 which are designed to engage pin 56 to fix mounting arm 22 in boat rod holder 50. Mounting arm 22 is thus constructed for mounting at a 30 degree angle with respect to the gunwale of the boat in rod holder 50 while rod holder support arm 32 is held substantially perpendicular to mounting arm 22 but at an elevated angle 44 of about 100 to 120 degrees and preferably about 105 degrees to mounting arm 22. Angle 44 as heretofore discussed is maintained by first taper 28 (FIG. 2). The rod 46 and reel 48 are also maintained at a rotational angle with respect to rod holder support arm 32 by pin 60. Pin 60 may include an optional ring 62 to assist in inserting and removing pin 60. In addition pin 60 may be interchangeable with pin 34 and may be a standard stainless steel pin as may be obtained from boating supply stores or a ¼-20×2½ SS Bolt and Nylock Nut.

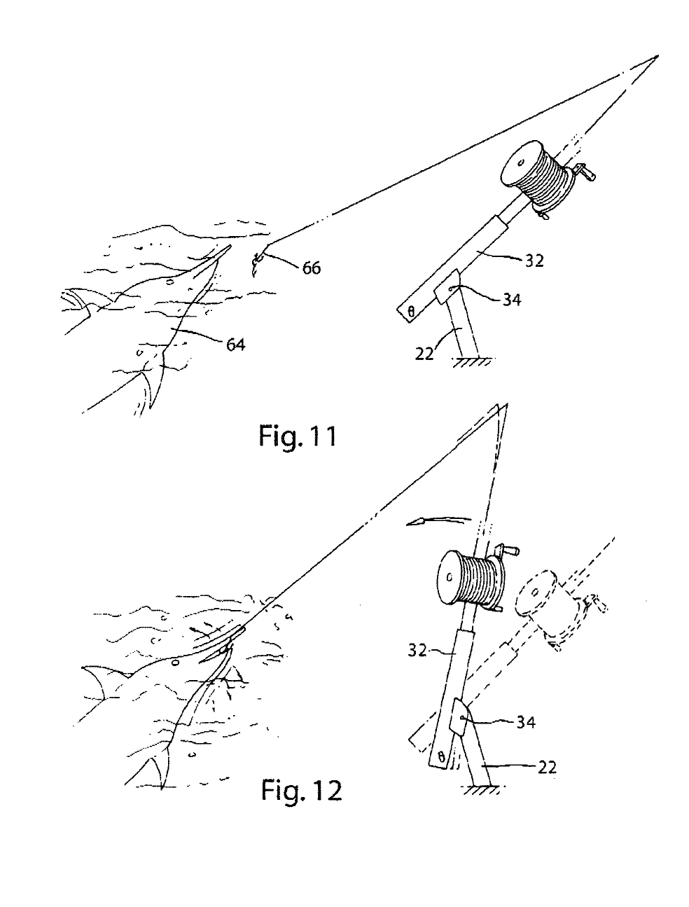

Referring now to FIGS. 7, 9, 10, 11, 12, 13 and 14 the novel outrigger with hooksetter is designed to hold the rods and reels in a combination of angles to allow the rod and reel to be pivoted from an armed position to a hooked setting position straight up and down as illustrated in FIG. 11. Once a fish 64 takes the bait or lure 66 the rod holder support arm 32 pivots along with the rod and reel from its armed position (FIG. 11) to its hook setting position (FIGS. 12 and 13) which results in an action-reaction occurrence that pivots rod holder support arm 32 around the hinge formed by pin 34 until the rod and reel pivot to the end of the travel as illustrated in FIG. 13 resulting in the stopping of the pivotal motion of rod holder support arm 32 by mounting arm 22 to result in a whip lash action of tip of rod or end 68 of rod 46 to automatically set hook 70 in fish 64.

The whip lash action-reaction occurrence not only sets hook 70 in fish 64 but results in the rod and reel being placed in a full upright position with the rod and reel in a position to be lifted out of rod holder support arm 32 without the necessity of the fisherman of having to reach over the side of the boat to try to remove the rod from standard fixed outriggers as are currently used in the prior art. The pivoting action of the rod holder support arm 32 around pin 34 utilizes the flexibility of the rod 46 at tip of rod 68 first moving in the direction of arrow 72 and subsequently moving in the opposite direction as illustrated by arrow 74 to leave the rod and reel in an upright position for the fisherman.

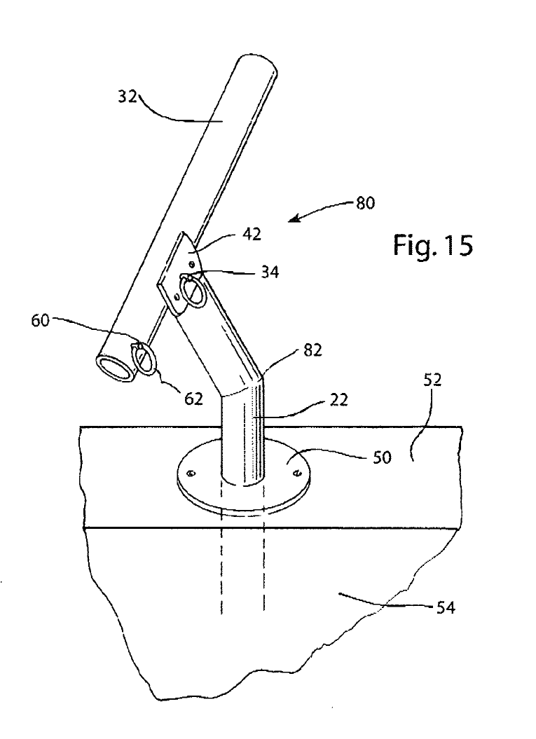

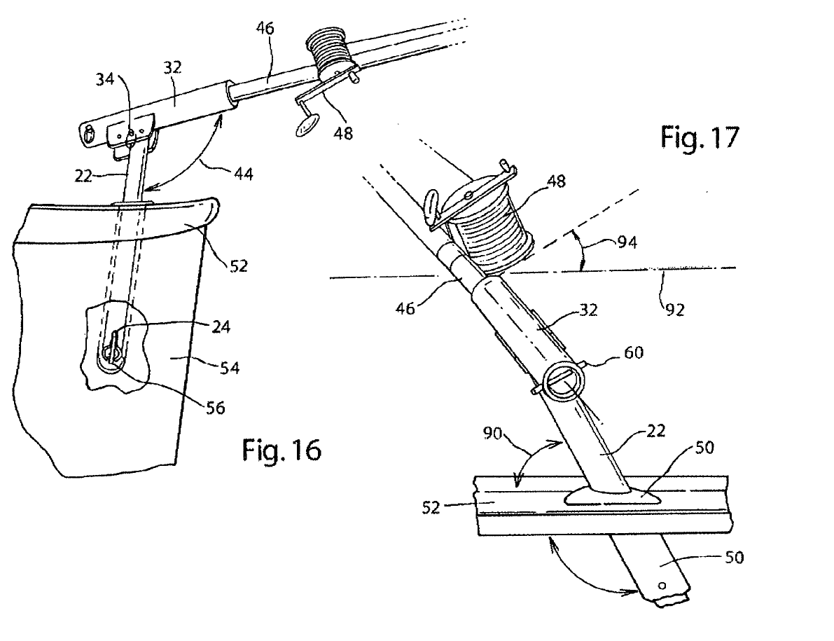

Referring now to FIG. 15 an alternative embodiment of the novel outrigger with hooksetter 80 is illustrated for mounting in a rod holder 50 or a borehole having a 0 degree angle or a 15 degree angle. The only difference between outrigger with hooksetter 80 and the previous embodiment of the outrigger with hooksetter 20 is the bend 82 provided in cylindrical mounting arm 22. The bend 82 is at an angle of about 5 to 45 degrees and preferably is about 15 to 30 degrees to position the novel outrigger with hooksetter 80 at the same 30 degree angle as is provided for by rod holders 50 having a 30 degree angle. The bend 82 allows the hinge provided at pin 32 to provide a pivot point which is at an angle of about 30 degrees from the horizontal plane which in combination with the rotational angle fixed by pin 60 maintains the rod and reel at an armed angle so that when the fish takes the bait the rod support arm 32 pivots around pin 34 to result in the same action-reaction occurrence as with outrigger with hooksetter 20.

Referring now to FIGS. 17 and 18 the relationship of angles believed responsible for providing the automatic hook setting feature of the novel outrigger 20 and 80 is the combination of angles which includes the angle between the mounting arm 22 and the rod support arm 32 as indicated by arrow 44. This angle should be about 100 to 120 degrees and preferably about 105 degrees while the angle between the gunwale and the mounting arm 22 represented by arrow 90 should be about 20 degrees to 40 degrees and preferably is 30 degrees. The angle between the reel 48 and the horizontal plane 92 as represented by arrow 94 should be about 5 degrees to 20 degrees which angle is maintained by pin 60 engaging slot 58 in rod 46 (FIG. 10). It is believed these combinations of angles are responsible for holding the hinge at an angle to the horizon as well as the rod and reel at an angle to the horizon which allows the action-reaction occurrence to result in the pivoting of the rod support arm 32 up against the mounting arm 22 to provide the automatic hook setting feature of the invention. It should be noted here that the horizon is an artificial horizon and is more properly merely a reference plane as the boat is constantly moving in trolling and the action of the waves rock the boat up and down or side to side in the action of wind and waves.

The mounting arm is preferably cylindrical and of a size sufficient to fit into the opening of a standard rod holder. The mounting arm is preferably hollow as well as the rod holder support arm although other shapes such as oval square or triangular may be employed. The mounting arm as well as the rod holder support arm may be made of metal such as aluminum or stainless steel or any other metal coated or uncoated that is resistant to a salt water environment. In addition the mounting arm as well as the rod holder support arm may be made of high density plastic materials such as polybutylene terephthalate.

The invention has been described with respect to the preferred embodiment and best mode for practicing the invention. Those skilled in the art will recognize that a number of modifications can be made to the invention such as modifications in the shape and diameter of the mounting arm to provide for the placement of the flanges on the end of the support arm as opposed to on the rod support arm as well as changes in modifying the angle between the mounting arm and the rod support arm by substituting a variable adjustment mechanism for varying the degree of the first taper. These and other modifications are intended to be included within the spirit and scope of the appended claims.

As used herein and in the following claims, the word ‘comprising’ or ‘comprises’ is used in its technical sense to mean the enumerated elements include but do not exclude additional elements which may or may not be specifically included in the dependent claims. It will be understood such additions, whether or not included in the dependent claims, are modifications that both can be made within the scope of the invention. It will be appreciated by those skilled in the art that a wide range of changes and modification can be made to the invention without departing from the spirit and scope of the invention as defined in the following claims:

What is claimed is:

1. A fishing outrigger with an automatic hooksetter comprising:
(a) a first tubular member having at one end an open end for receiving a fishing rod and at the other end a fishing rod positioning pin;
(b) a second tubular member having at one end a tubular member positioning slot for fixing the angular rotational position of said second tubular member, said second tubular member having at the other end a taper for positioning and limiting the angular travel of said first tubular member to said second tubular member; and
(c) a hinge for connecting said first tubular member to said second tubular member.

2. The fishing outrigger of claim 1 wherein said hinge is a pair of flanges disposed intermediate the ends of said first tubular member having a hole and an interconnecting pin.

3. The fishing outrigger of claim 2 wherein said pair of flanges have a plurality of holes for adjusting the position of said first tubular member to said second tubular member.

4. The fishing outrigger of claim 1 wherein said hinge includes a plurality of holes and a moveable hinge pin for adjusting the position of said hinge.

5. The fishing outrigger of claim 1 wherein said second tubular member is bent at an angle of about 5 degrees to 40 degrees intermediate said tubular member positioning slot and said taper.

6. The fishing outrigger of claim 1 wherein said fishing rod positioning pin is in substantial planar alignment with said hinge.

7. The fishing outrigger of claim 1 further comprising a second taper allowing said first tubular member to be in substantial parallel alignment to said second tubular member and wherein said taper for positioning and limiting angular travel provides an angle of about 100 degrees to 120 degrees between said first tubular member and said second tubular member when joined by said hinge.

8. A fishing article of manufacture comprising:
(a) a mounting arm having means at one end adapted for angular mounting in a fishing rod holder having a circular opening and said mounting arm having at the other end a first taper and a second taper;
(b) a fishing rod support arm having a substantially cylindrical opening pivotally mounted to said mounting arm with said first taper setting an angular position of said mounting arm to said fishing rod support arm, said second taper allowing said fishing rod support to pivot to a position of substantial parallel alignment to said mounting arm; and
(c) a locking pin disposed intermediate the ends of said fishing rod support arm for angularly positioning a fishing rod in said fishing rod support arm.

9. The fishing article of claim 8 further comprising a slot in one of the ends of said mounting arm for angular mounting of said mounting arm in said fishing rod holder.

10. The fishing article of claim 8 further comprising a flange and a plurality of holes disposed in said flange for adjusting a pivotal mounting of said fishing rod support arm to said mounting arm.

11. The fishing article of claim 8 wherein said means at one end adapted for angular mounting is a bend in said mounting arm.

12. The fishing article of claim 8 wherein said means at one end adapted for angular mounting is a tubular member having a slot at one end for angularly mounting said mounting arm in an angularly mounted fishing rod holder.

13. The fishing article of claim 8 wherein said first taper on said mounting arm sets said angular position of said fishing rod support arm to said mounting arm at an angle of about 100 degrees to 120 degrees.

14. The fishing article of claim 8 wherein said first taper on said mounting arm sets said angular position of said fishing rod support arm to said mounting arm at an angle of about 105 degrees.

15. The fishing article of claim 8 wherein said first taper on said mounting arm sets said angular position of said fishing rod support arm to said mounting arm at an angle of about 110 degrees.

16. A fishing device with automatic hooksetter comprising:
(a) a substantially hollow fishing rod support arm for receiving a fishing rod, said substantially hollow fishing rod support having a fishing rod positioning and anchoring pin disposed through said substantially hollow fishing rod support arm;
(b) a pair of flanges disposed on opposite sides of said substantially hollow fishing rod support arm, said flanges disposed substantially perpendicular to said fishing rod positioning and anchoring pin and having a flange hole disposed in a plane substantially parallel to said fishing rod positioning and anchoring pin;
(c) a support member having at one end a substantially cylindrical end for mounting to a fishing rod holder and at the other end a first taper for setting an angular position of said support member to said substantially hollow fishing rod support arm and a second taper for allowing said substantially hollow fishing rod support arm to pivot to a position substantially parallel to said support member;
(d) a mounting hole disposed intermediate the ends of said support member; and
(e) a pivot pin for connecting said flange hole with said mounting hole.

17. The fishing device of claim 16 further comprising a plurality of flange holes in said pair of flanges.

18. The fishing device of claim 16 wherein said support member includes a bend of about 5 degrees to 40 degrees disposed intermediate said substantially cylindrical end and said other end.

19. The fishing device of claim 16 wherein said first taper for setting said angular position sets an angle of about 100 degrees to 120 degrees.

20. The fishing device of claim 16 wherein said fishing rod positioning and anchoring pin sets a reel of a fishing rod at an angle of about 0 degrees to 20 degrees to a horizontal plane.
